(19) United States
(12) Patent Application Publication
(10) Pub. No.: US 2016/0285108 A1
(43) Pub. Date: Sep. 29, 2016

(54) Rechargeable Magnesium Oxygen Battery

(71) Applicants: THE REGENTS OF THE UNIVERSITY OF MICHIGAN, Ann Arbor, MI (US); DENSO CORPORATION, Kariya-shi (JP)

(72) Inventors: Junichi NARUSE, Kariya (JP); Hidehiko HIRAMATSU, Nissin-shi (JP); Donald SIEGEL, Ann Arbor, MI (US); Jeffrey SMITH, Ann Arbor, MI (US); Gulin VARDAR, Ann Arbor, MI (US); Charles MONROE, Oxford (GB)

(21) Appl. No.: 14/955,484

(22) Filed: Dec. 1, 2015

Related U.S. Application Data
(60) Provisional application No. 62/136,968, filed on Mar. 23, 2015.

(51) Int. Cl. H01M 4/90; H01M 12/08

(52) U.S. Cl. CPC H01M 4/9016; H01M 12/08; H01M 2220/20

(57) ABSTRACT

A rechargeable magnesium oxygen battery, which can be recharged with high efficiency, including a negative electrode, a positive electrode, and an electrolyte catalyst. The negative electrode is configured to release magnesium ions during discharge of the battery, and configured to precipitate elemental magnesium during charging of the battery. The positive electrode is configured to precipitate discharge products that include at least magnesium and oxygen during discharge of the battery, and for releasing magnesium ions during charging of the battery. The electrolyte catalyst is between the negative electrode and the positive electrode. The electrolyte catalyst can be any suitable compound configured to facilitate adsorption of at least one of the electrolyte catalyst and anions thereof on the discharge product.

### CROSS-REFERENCE TO RELATED APPLICATION

This application claims the benefit of U.S. Provisional Application No. 62/136,968 filed on Mar. 23, 2015, the entire disclosure of which is incorporated herein by reference.

### FIELD

The present disclosure relates to a rechargeable magnesium oxygen battery.

### BACKGROUND

This section provides background information related to the present disclosure, which is not necessarily prior art.

Rechargeable magnesium oxygen batteries are suitable for use in hybrid and electric vehicles for vehicle propulsion, but are subject to improvement. For example, a rechargeable magnesium oxygen battery capable of being recharged with greater efficiency would be desirable. The present teachings address this need.

### SUMMARY

This section provides a general summary of the disclosure, and is not a comprehensive disclosure of its full scope or all of its features.

The present teachings provide for a rechargeable magnesium oxygen battery including a negative electrode, a positive electrode, and a non-aqueous magnesium on conductor between the negative and positive electrodes. An electrolyte catalyst is included with the non-aqueous magnesium on conductor. The electrolyte catalyst includes anions. Configured to adsorb on the discharge product is the electrolyte catalyst, anions of the electrolyte catalyst, or both the electrolyte catalyst and the anions thereof. The battery can be recharged with high efficiency.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of a rechargeable magnesium oxygen battery according to the present teachings;

FIG. 2 illustrates one example of a recharge reaction of the rechargeable magnesium oxygen battery according to the present teachings, either a chloride anion or an organic anion of an electrolyte catalyst can be adsorbed on MgOx, and alternatively the entire electrolyte catalyst can also be adsorbed on MgOx;

FIG. 3 illustrates effects of catalyst adsorption on MgOx;

FIG. 4 illustrates additional effects of catalyst adsorption on MgOx; and

FIG. 5 is a graph illustrating that the rechargeable magnesium oxygen battery according to the present teachings is rechargeable to 100% of its original capacity.

### DETAILED DESCRIPTION

Example embodiments will now be described more fully with reference to the accompanying drawings.

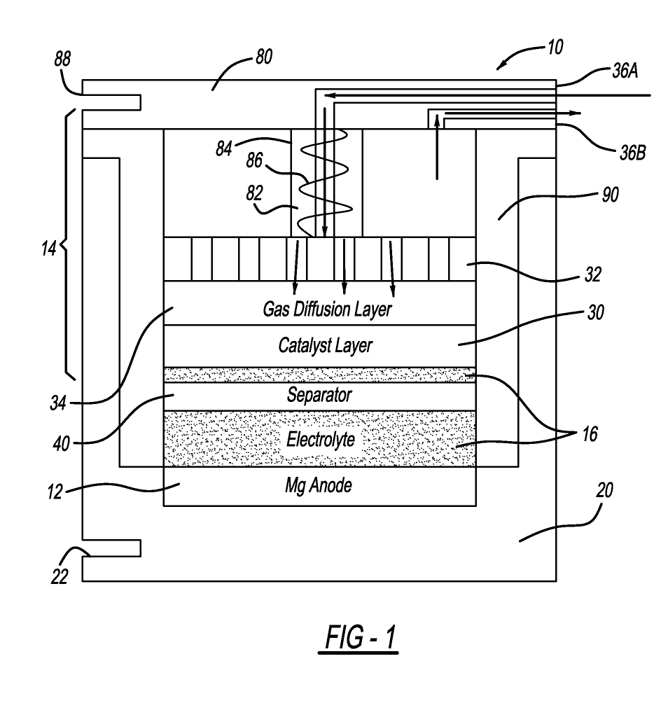

With reference to FIG. 1, an exemplary rechargeable magnesium oxygen battery according to the present teachings is illustrated at reference numeral 10. The battery 10 generally includes a negative electrode 12, a positive electrode 14, and a non-aqueous electrolytic solution 16 between the negative electrode 12 and the positive electrode 14. The arrangement of the battery 10 illustrated is for exemplary purposes only. The battery 10 can have numerous other configurations in addition to the configuration illustrated in Figure

The negative electrode 12 can be any suitable electrode configured to adsorb magnesium and release magnesium ions. The negative electrode 12 may include any suitable active material layer configured to adsorb and release the magnesium ion. The active material of the negative electrode 12 is not limited to a specific material. Instead, the active material may be any suitable conventional material. For example, the active material can be metallic magnesium having a diameter of 14 millimeters and a thickness of 0.1 millimeters (with 99.9% purity made by Goodfellow Cambridge Limited, for example). Alternatively, the active material may be a metallic material such as magnesium alloy, or a compound for adsorbing and releasing the magnesium ion. Still further, the active material may be a combination of these materials. An accessory component of the magnesium alloy may be included, such as aluminum, zinc, manganese, silicon, calcium, iron, copper or nickel. The negative electrode 12 can be arranged in any suitable manner, such as on a lower casing 20 of the battery 10, for example. The lower casing 20 may be made of any suitable material, such as stainless steel. The lower casing 20 can include an electrical connection location 22 for the negative electrode 12.

The negative electrode 12 can include any suitable compound for adsorbing and releasing magnesium ions, such as graphite or any other suitable material having a large capacity for charge. Alternatively, the compound may be made of a group 4B metallic element in the short format periodic table (or any other suitable metallic element), or a single body or alloy of half metal, such as silicon and tin, or the like. Specifically, the compound may be made of an alloy including silicon and/or tin, or a carbon material such as graphite and amorphous carbon. A single body of these compounds may be used as the active material. Alternatively, a combination of these compounds may be used as the active material.

When the active material layer is distributed on the negative electrode 12, the active material layer may be applied to a current collector to form the negative electrode 12. Any suitable current collector may be used as long as the current collector has suitable conductivity. The current collector may be, for example, a foil or a mesh of copper, stainless steel, titanium or nickel. Further, any other suitable part of the battery 10 including these materials may act as the current collector.

The positive electrode 14 may be any electrode suitable for producing a discharge product that includes at least magnesium and oxygen during discharge of the battery 10. The discharge product can be binary compound (MgOₓ) or ternary compound (MgAₓB_{y}, (A=O, and B=Cl, C, H)), where “x” and “y” are integers and “x” may or may not be equal to “y.” MgOₓ can be magnesium oxide (MgO), magnesium peroxide (MgO₂), or magnesium superoxide (Mg(O₂)₂). For example, the discharge products may be MgO₂. The positive electrode 14 may include any suitable catalyst or promoter in order to promote production of the discharge products during discharge of the battery 10. The catalyst may be preloaded on the positive electrode 14 in any suitable manner. For example and as illustrated in FIG. 1, the positive electrode 14 may have a catalyst layer 30 including the promoter. The catalyst layer 30 may be arranged adjacent to the non-aqueous electrolyte solution 16, and between the non-aqueous electrolyte solution 16 and a gas diffusion layer 34. The gas diffusion layer 34 is between the catalyst layer 30 and a current collector 32.

Between the catalyst layer 30 and the negative electrode 12 is a separator 40. The separator 40 can be any suitable separator, such as a Glass Fiber Separator (ECC1-01-0012-A/L) from EL-Cell GmbH of Germany. The separator 40 can be any suitable separator configured to insulate the negative electrode 12 and the positive electrode 14 electrically so that the non-aqueous electrolytic solution 16 permeates the separator 40. The separator 40 can be, for example, a porous synthetic resin film such as polyolefin polymer porous film. Specifically, the separator 40 can be a polyethylene polymer porous film or a poly propylene porous film. Alternatively, the separator 40 may be a resin non-woven cloth, a glass fiber non-woven cloth, or the like. The non-aqueous electrolytic solution 16 is between the catalyst layer 30 of the positive electrode 14 and the negative electrode 12.

The electrolyte solution 16 may be any suitable electrolyte solution, such as a non-aqueous magnesium ion conductor, suitable for conducting magnesium ion between the negative electrode 12 and the positive electrode 14. To facilitate recharging the battery 10 to 100%, the electrolyte solution 16 includes any suitable electrolyte catalysts. The catalyst can be any compound present in the electrolytic solution 16 that facilitates the adsorption of the catalyst and/or anions thereof on the discharge product. Thus, in addition to facilitating the adsorption of other anions, the catalyst itself may be an anionic species that adsorbs on the discharge product. The catalyst can thus include anions. The catalyst and/or the anions thereof are configured to adsorb on discharge products, such as MgOₓ for example, at greater than the decomposition potential of MgOₓ. The “decomposition potential” means ideally the equilibrium potential of MgOₓ and Mg+O₂. For example, the equilibrium potential of MgO and Mg+O₂ is about 2.9V, and the equilibrium potential of MgO₂ and Mg+O₂ is about 2.9V. The decomposition potential of MgOₓ can be lower than the equilibrium potential due to defects and so on. The electrolyte solution 16 can be an electrolyte, such as: (PhMgCl)₄—Al(OPh)₃ in tetrahydrofuran (THF) ((CH₂)₄O), with “Ph” being any suitable C₆H₅ phenyl group. The electrolyte catalyst is formed in this electrolyte.

The electrolyte catalyst may be formed in any other magnesium electrolyte such as all-phenyl complex (APC) or magnesium aluminum chloride complex (MACC). The electrolyte catalyst can be, for example, MₓA_{y} (M=Mg, Al, B, Ga; A=halogen or organic group) or MₓA_{y}B_{z} (M=Mg, Al, B, Ga; A=halogen or organic group; B=halogen or organic group), where “x,” “y,” and “z” are integers and “x” may or may not be equal to “y” and “z.” For example, the electrolyte catalyst may be MgCl₃⁻, MgCl₄²⁻, AlCl₄⁻, (OPh)AlCl₃⁻, GaCl₄⁻, BCl₄⁻. The solvent is not limited to THF. Any other solvent and ionic liquid can be used instead of THF. As explained herein, the electrolyte catalyst includes anions. The electrolyte catalyst and/or the anions thereof are configured to adsorb on the discharge product, which raises the energy of valence of the discharge product and results in the battery 10 being capable of being recharged with high efficiency. This is at least in part because electron transfer from MgOₓ to the electrode is a limiting factor during recharge, and the position of the energy of valence (EOV) impacts the rate of electron transfer.

The non-aqueous electrolytic solution 16 may include any suitable organic solvent, such as one kind or a combination of multiple kinds of conventional non-aqueous electrolytic solutions. For example, the organic solvent may be cyclic ester, chained ester, cyclic ether, chained ether, cyclic carbonate, chained carbonate, or a combination of these solvents. Specifically, an exemplary chained ether compound is diethylene glycol dimethyl ether. An exemplary cyclic ether compound is tetrahydrofuran. An exemplary cyclic carbonate is ethylene carbonate or propylene carbonate. An exemplary chained carbonate is dimethyl carbonate or diethyl carbonate. When the non-proton organic solvent has a high degree of solubility of oxygen, the oxygen dissolved is used effectively for the reaction. The ionic liquid is not limited to a specific liquid as long as the ionic liquid is used for the non-aqueous electrolytic solution in the rechargeable battery 10. An exemplary cation component is 1-methyl-3-ethyl imidazolium cation or diethyl methyl (methoxy) ammonium cation. An exemplary anion component is BF₄⁻ or (SO₂C₂F₅)₂N⁻.

The positive electrode 14 can be an air electrode including any suitable active material. such as oxygen gas. As illustrated in FIG. 1. the battery 10 can include an oxygen inlet 36A (and an oxygen outlet 36B) for introducing external air with oxygen, such as atmospheric air, by way of perforated current collector 32 and gas diffusion layer 34 for diffusing the oxygen gas to the catalyst layer 30. More specifically, the oxygen net 36A can extend through a cap 80 of the battery 10. which can be a stainless steel cap 80, and through a bore 82 defined by a polytetrafluoroethylene (FIFE) rod 84 arranged between the cap 80 and the current collector 32 to direct oxygen to the current collector 32. The FIFE rod 84 can include a spring 86, or any other suitable device, to compress the contents of the battery 10. The spring 86 may be any suitable conductive spring, such as a gold plated spring. Thus, the cap 80 can be conducted to the positive electrode 14 by way of the gold plated spring 86 press-bonded to the current collector 32 and insulated from the stainless steel of the lower casing 20. A polytetrafluoroethylene (PTFE) layer 90 insulates the negative electrode 12 and the positive electrode 14. The oxygen gas may be in the external air or supplied from a high concentration oxygen container, which can be filled using any suitable method. For example, the oxygen gas may be supplied from a pure oxygen gas container or other oxygen storage device.

The gas diffusion layer 34 can be any suitable gas diffusion layer. For example, the gas diffusion layer 34 can include carbon paper (Sigracet 25BC made by Ion Power, Inc., for example). The gas diffusion layer 34 can be mounted on the current collector 32. An electrical connection point 88 for the positive electrode 14 can be included at the cap 80. The positive electrode 14 can thus be an air electrode including the current collector 32, the catalyst layer 30, the carbon paper of the gas diffusion layer 34, and the oxygen gas.

The catalyst layer 30 includes any suitable compound that promotes the formation of discharge products that are easily decomposed during recharge, such as metal and metal oxides, for example platinum. MnO₂ or MgO₂ (the promoter/catalyst in catalyst layer 30 is different from the catalyst of the electrolytic solution 16). In view of the smooth progression of the electrochemical reaction, the oxidation catalyst and/or the catalyst layer 30 may have high conductivity. In this case, the promoter may include a conductive member and/or a bonding member for bonding the conductive member and the promoter. The conductive member may be any suitable conductive member having suitable conductivity. For example, the conductive member may be carbon material or metallic powder. The carbon material can be, for example, graphite, acetylene black, ketjen black, carbon black, or carbon fiber. The bonding member can be any suitable bonding member. For example, the bonding member can be polyvinylidene difluoride (PVDF), polytetrafluoroethylene (PTFE), fluorinated ethylene ethylene-propylene copolymer (fluorine resin copolymer), or rubber resin such as ethylene propylene diene monomer (EPDM), styrene-butadiene rubber, and nitrile rubber.

The gas diffusion layer 34 diffuses the oxygen gas introduced from the inlet 36A to the catalyst layer 30 during a discharge reaction of the battery 10. When the battery 10 is being recharged, the gas diffusion layer 34 diffuses the produced oxygen gas to the outlet 36B. The gas diffusion layer 34 may be, for example, a conductive sheet made of carbon or the like and may be porous. For example, the gas diffusion layer 34 can include carbon paper, a carbon cloth, or a carbon felt, for example.

The current collector 32 is configured to collect current, which is generated by the electrochemical reaction of the battery 10. The current collector 32 can be made of any material having suitable conductivity. For example, the current collector 32 can include nickel, stainless steel, platinum, aluminum, or titanium. The current collector 32 can have any suitable shape, and can be a foil, a plate, or a mesh, for example. To secure diffusion of the oxygen gas, the current collector 32 can have a mesh shape, for example. In the example illustrated, the current collector 32 can be perforated and include stainless steel coated with platinum.

The battery 10 is not limited to a specific shape. For example, the battery 10 can have a coin shape, a cylindrical shape, a square shape, or the like. The battery 10 is not limited to a specific vessel. For example, the vessel may be a vessel made of metal or resin, which maintains an outer shape, a soft vessel such as laminate pack, or the like. The vessel of the battery 10, may be an open-air type vessel or a closed type vessel when the battery 10 includes the air electrode.

During discharge of the battery 10. discharge products that include at least magnesium and oxygen, as explained above, are produced at the positive electrode 14. The discharge products, such as MgOₓ (MgO, MgO₂, or Mg(O₂)₂), are produced during the discharging process using oxygen as the positive electrode active material. With respect to magnesium peroxide (MgO₂), the electrochemical reaction to be promoted at the positive electrode 14 in the discharging process is the following:

Mg²⁺+O₂+2e−→MgO₂

With respect to magnesium oxide (MgO), the electrochemical reaction to be promoted at the positive electrode 14 in the discharging process is:

2Mg²⁺+O₂+4e−→2MgO₂

With respect to MgO₂, the electrochemical reaction promoted at the positive electrode 14 during charging of the battery 10 is the following:

MgO₂→Mg²⁺+O₂+2e−

With respect to MgO, the electrochemical reaction promoted at the positive electrode 14 during charging of the battery 10 is the following:

2MgO→2Mg²⁺+O₂+4e−

During discharge of the battery 10, at the negative electrode 12 the metal magnesium as the negative electrode active material discharges electrons so that magnesium ions are produced. Thus, the magnesium ions are soluble in the non-aqueous type magnesium on conductor. At the positive electrode 14, oxygen receives the electrons, which are discharged from the magnesium at the negative electrode, through an external circuit so that the oxygen is reduced and ionized. Further, the oxygen on is combined with the magnesium on in the electrolyte solution 16 so that the discharge product is formed according to the reaction above.

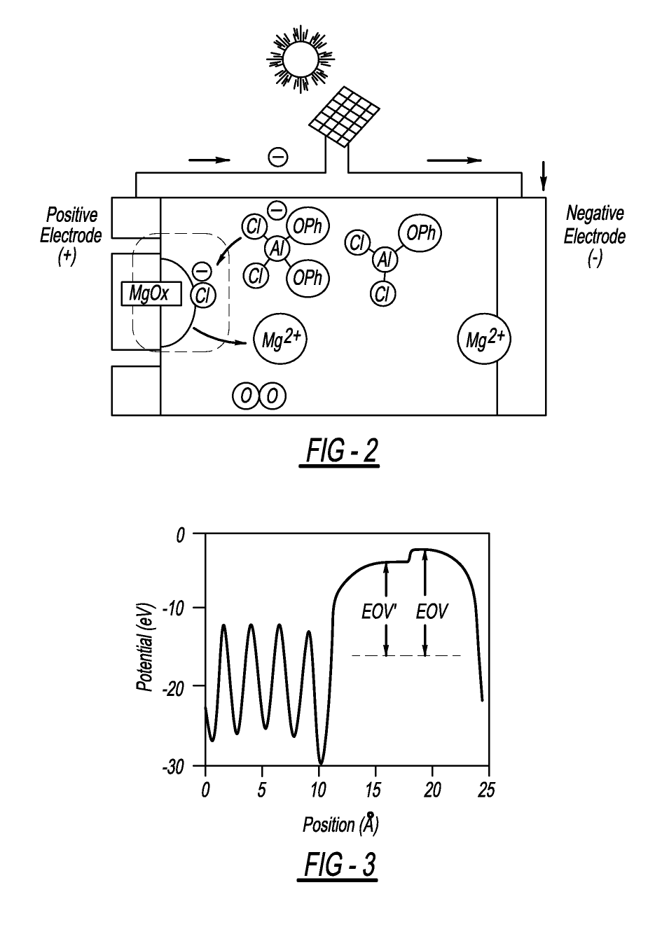

When the battery 10 is charged, the discharge product is decomposed so that the electron is retrieved therefrom. As illustrated in FIG. 2, an electrolyte catalyst according to the present teachings adsorbs on the discharge product, such as MgO or MgO₂. The electrolyte catalyst can include any suitable halogen (such as F⁻, Cl⁻, Br⁻, or I⁻, for example) or any suitable organic group (such as phenyl group (C₆H₅⁻), phenol group (OC₆H₅⁻), ethyl group (C₂H₅⁻), p-aminohippurate (PAH), cyclic nucleotides, prostaglandins, or dicarboxylates, for example).

Thus, the discharge product is oxidized to release oxygen. Further, the magnesium ion is released to the non-aqueous electrolytic solution 16 according to the equation above. At the negative electrode 12, the magnesium ion in the non-aqueous electrolytic solution 16 receives the electron, which is retrieved from the discharge product, through the external circuit, so that the metal magnesium is formed.

Adsorption of electrolyte catalysts on MgOₓ provides numerous advantages. For example and as illustrated in FIG. 3, the electrolyte catalyst raises the energy of valence of MgO₂ about 1.5 eV compared to that of MgO₂ without electrolyte catalyst adsorption. Higher energy of valence makes MgOₓ easier to be decomposed by electron transfer from MgOₓ to electrode and raises recharge efficiency of the battery 10.

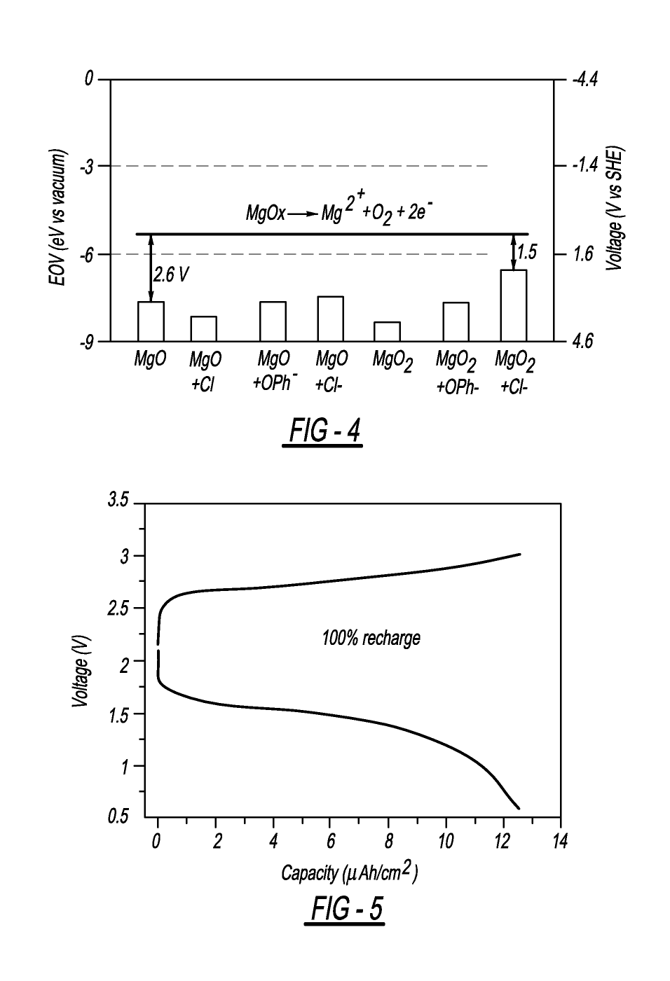

As illustrated in FIG. 4, for example, the energy of valence of MgO with OPh⁻ of an electrolyte catalyst adsorbed thereon, as well as the energy of valence of MgO with Cl⁻ of an electrolyte catalyst adsorbed thereon, is greater than the energy of valence of MgO without electrolyte catalyst adsorbed thereon. The energy of valence of MgO with Cl⁻ of an electrolyte catalyst adsorbed thereon is greater than the energy of valence of MgO with OPh⁻ of an electrolyte catalyst adsorbed thereon. Similarly, the energy of valence of MgO₂ with Cl⁻ of an electrolyte catalyst adsorbed thereon is greater than the energy of valence of MgO₂ with OPh⁻ of an electrolyte catalyst adsorbed thereon, which is greater than the energy of valence of MgO₂ without a catalyst adsorbed thereon. The energy of valence of MgO₂ with Cl⁻ of an electrolyte catalyst adsorbed thereon is greater than the energy of valence of MgO with Cl⁻ of an electrolyte catalyst adsorbed thereon. Catalyst adsorption, although illustrated in FIG. 4 for the examples of MgO and MgO₂, will yield similar benefits for a more general discharge product, such as one having a different stoichiometry than MgOₓ.

This increase in the energy of valence resulting from use of the electrolyte catalyst that includes anions according to the present teachings provides numerous advantages. For example, the increased energy of valence results in a reduced overvoltage. The change in energy of valence position and increase in energy of valence facilitates MgOₓ decomposition, and thus facilitates recharging of the battery 10. Furthermore, a lower recharge voltage is required, particularly with applications where Cl⁻ from the catalyst is adsorbed on MgO₂. Also, and with reference to FIG. 5 for example, the battery 10 can be recharged to about 100% of its capacity. Specifically, in the example of FIG. 5 the battery 10 having an original or discharge capacity of 12 μAh/cm² can be recharged to about 12 μAh/cm².

The energy of valence is obtained by first principle simulation using Density Functional Theory. First-principle simulations were performed using the Vienna ab initio simulation package (VASP code).

While the present disclosure has been described with reference to embodiments thereof, it is to be understood that the disclosure is not limited to the embodiments and constructions. The present disclosure is intended to cover various modification and equivalent arrangements. In addition to the various combinations and configurations described, other combinations and configurations, including more, less or only a single element, are also within the spirit and scope of the present disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A rechargeable magnesium oxygen battery comprising:
a negative electrode configured to release magnesium ions during discharge of the battery, and configured to precipitate elemental magnesium during charging of the battery;
a positive electrode configured to precipitate discharge product that includes at least magnesium and oxygen during discharge of the battery and for releasing magnesium ions and oxygen during charging of the battery; and
a non-aqueous magnesium ion conductor between the negative electrode and the positive electrode; and
an electrolyte catalyst included with the non-aqueous magnesium ion conductor, the electrolyte catalyst includes anions;
wherein configured to adsorb on the discharge product is the electrolyte catalyst, anions of the electrolyte catalyst, or both the electrolyte catalyst and the anions thereof.

2. The rechargeable magnesium oxygen battery of claim 1. wherein the electrolyte catalyst includes anions and adsorbs on the discharge product at greater than the decomposition potential of the discharge product.

3. The rechargeable magnesium oxygen battery of claim 2, wherein the decomposition potential of the discharge product is more than 2.5V.

4. The rechargeable magnesium oxygen battery of claim 1, wherein:
the discharge product includes MgOₓ or MgAₓB_{y};
MgOx is one of magnesium oxide (MgO), magnesium peroxide (MgO₂), and magnesium superoxide (Mg(O₂)₂); and
A=O and B=Cl, C, or H.

5. The rechargeable magnesium oxygen battery of claim 1, wherein the electrolyte catalyst includes anions and adsorbs on magnesium oxide (MgO) to provide an anion adsorption state on a surface of MgO having an energy of valence that is higher than that of magnesium oxide (MgO).

6. The rechargeable magnesium oxygen battery of claim 1, wherein the electrolyte catalyst includes anions containing halogen and adsorbs on magnesium oxide.

7. The rechargeable magnesium oxygen battery of claim 6, wherein the electrolyte catalyst includes anions containing chlorine and adsorbs on magnesium oxide.

8. The rechargeable magnesium oxygen battery of claim 1, wherein the electrolyte catalyst includes organic anions and is configured to adsorb on magnesium oxide.

9. The rechargeable magnesium oxygen battery of claim 1, wherein the electrolyte catalyst includes anions and is configured to adsorb on magnesium peroxide (MgO₂) to provide an anion adsorption state on a surface of MgO₂ having an energy of valence that is higher than that of magnesium peroxide (MgO₂).

10. The rechargeable magnesium oxygen battery of claim 1, wherein the electrolyte catalyst includes anions containing halogen and is configured to adsorb on magnesium peroxide (MgO₂).

11. The rechargeable magnesium oxygen battery of claim 10, wherein the electrolyte catalyst includes anions containing chlorine and is configured to adsorb on magnesium peroxide (MgO₂).

12. The rechargeable magnesium oxygen battery of claim 1, wherein the electrolyte catalyst includes organic anions and is configured to adsorb on magnesium peroxide (MgO₂).

13. The rechargeable magnesium oxygen battery of claim 1, wherein the electrolyte catalyst is formed in (PhMgCl)₄—Al(OPh)₃ in solvent, and “Ph” is a phenyl group.

14. The rechargeable magnesium oxygen battery of claim 13, wherein the electrolyte catalyst is adsorbed in a solvent.

15. The rechargeable magnesium oxygen battery of claim 14, wherein the solvent includes ether.

16. A rechargeable magnesium oxygen battery comprising:
a negative electrode configured to release magnesium ions during discharge of the battery, and configured to precipitate elemental magnesium during charging of the battery;
a positive electrode configured to precipitate discharge product that includes at least magnesium and oxygen during discharge of the battery and for releasing magnesium ions and oxygen during charging of the battery; and
a non-aqueous magnesium on conductor between the negative electrode and the positive electrode; and
an electrolyte catalyst included with the non-aqueous magnesium on conductor, the electrolyte catalyst is a magnesium aluminum chloride complex including anions containing chlorine;
wherein configured to adsorb on the discharge product is the electrolyte catalyst, anions of the electrolyte catalyst, or both the electrolyte catalyst and the anions thereof.

17. The rechargeable magnesium oxygen battery of claim 16, wherein the magnesium aluminum chloride complex includes a chloride ion and is configured to adsorb on magnesium peroxide (MgO₂) to provide an anion adsorption state on a surface of MgO₂ by anions having energy of valence that is higher than magnesium peroxide (MgO₂).

18. The rechargeable magnesium oxygen battery of claim 16, wherein the electrolyte catalyst is formed in (PhMgCl)₄—Al(OPh)₃ in solvent, and “Ph” is a phenyl group.

19. The rechargeable magnesium oxygen battery of claim 18, wherein the electrolyte catalyst is adsorbed in a solvent.

20. The rechargeable magnesium oxygen battery of claim 19, wherein the solvent includes ether.
